(19) United States
(12) Patent Application Publication
(10) Pub. No.: US 2010/0052293 A1
(43) Pub. Date: Mar. 4, 2010

(54) MOBILE MODULAR CART/CASE SYSTEM FOR OXYGEN CONCENTRATORS AND INFUSION PUMP SYSTEMS

(76) Inventors: Vincent L. Brooks, Troy, MI (US); Mark E. Piche, Troy, MI (US)

Correspondence Address: Delphi Technologies, Inc., M/C 480-410-202, PO BOX 5052, Troy, MI, 48007, US

(21) Appl. No.: 12/201,716

(22) Filed: Aug. 29, 2008

(51) Int. Cl. B62B 1/00

(52) U.S. Cl. 280/651

(57) ABSTRACT

An apparatus for operatively carrying and providing ready access to the operation of a portable oxygen concentration module is provided. The apparatus comprises a carrying case having a hollow body portion defining a first inner chamber therein, a lower end configured to stabilize the carrying case in an upright position when the carrying case is rested on a generally planar surface, and an upper end defining a primary opening to the first inner chamber. The primary opening is sized and configured to permit the oxygen concentration module to be deposited into the first inner chamber therethrough. The first inner chamber is sized and configured to receive and operatively retain the oxygen concentration module therein. The apparatus further comprises a plurality of intake vents integrated within the hollow body portion, a plurality of exhaust vents integrated within the hollow body portion, and a first aperture integrated within the carrying case. The intake vents are positioned to align with inlet vents of the oxygen concentration module when the oxygen concentration module is received within the first inner chamber to permit ambient air to be drawn into the oxygen concentration module from a surrounding atmosphere. The exhaust vents are positioned to align with outlet vents of the oxygen concentration module when the oxygen concentration module is received within the first inner chamber to permit exhaust gas to be vented from the oxygen concentration module to the surrounding atmosphere. The first aperture is positioned to align with an outlet port of the oxygen concentration module when the oxygen concentration module is received within the first inner chamber to allow attachment of an oxygen delivery tube to the outlet port of the oxygen concentration module.

### BACKGROUND

Exemplary embodiments of the present invention relate to transportation of medical devices, and, more specifically, exemplary embodiments of the present invention relate to operability and ease of mobility during transportation of ambulatory medical devices.

Supplemental oxygen therapy is a common, increasingly beneficial, and oftentimes-required prescription to help patients exhibiting symptoms from certain diseases and lung disorders such as pulmonary fibrosis, sarcoidosis, or occupational lung disease live normal and productive lives. For example, while not a cure for lung disease, prescriptive supplemental oxygen increases blood oxygenation, which reverses hypoxemia. Oxygen prescriptions can help prevent long-term effects of oxygen deficiency on organ systems, the heart, brain, and kidneys. Oxygen treatment is also prescribed for Chronic Obstructive Pulmonary Disease (COPD), heart disease, AIDS, asthma, and emphysema.

Currently, supplemental medical oxygen for therapy is provided to a patient from high-pressure gas cylinders, cryogenic liquid in vacuum-insulated containers or thermos bottles commonly called “dewars”, and oxygen concentrators. Some patients require in-home oxygen only, while others require in-home as well as ambulatory oxygen depending on the prescription. The three systems are all used for in-home use. Oxygen concentrators provide a beneficial advantage in that they produce oxygen concentrated air on a constant basis by filtering charged or compressed intake ambient air through a molecular sieve bed or pressure swing adsorption (PSA) system to separate or absorb nitrogen.

Nevertheless, while effective at continual production of oxygen, oxygen concentrators do have drawbacks. They tend to consume relatively large amounts of electricity, be relatively large and heavy, emit excessive heat, and be relatively noisy. In an attempt to reduce the size and weight of oxygen concentrators and provide patients with greater mobility, there has been a movement toward design of portable oxygen concentrators. The currently available portable oxygen concentrators, however, do not necessarily provide patients with the ease of mobility that they desire. The portable concentrators tend to generate as much noise as the stationary units and thus are not suitable for use at places such as the theater or library where such noise is prohibited. Moreover, the present portable concentrators have very short battery life, typically less than one hour, and thus cannot be used continuously for any length of time without an external power source. As a result, many patients requiring the use of oxygen concentrators are tethered to the stationary machines and inhibited in their ability to lead an active life.

It is also common for patients having certain medical problems to require periodic delivery of premeasured infusions of fluid, medication, or nutrients, into their bodies. Examples of such patients are those who require nutrients to be delivered directly into their digestive tract periodically over long periods of time, or cancer patients who require exacting amounts of medication to be delivered intravenously at precise periods of time. For these purposes, pumps are typically found in hospitals and other point of care environments.

In the past, such patients required hospitalization in order to allow medical personnel to perform the infusions at the proper time and in the proper amounts. Such procedures were extremely time consuming to the patient and also the hospital personnel, had the potential of human error in calculation of infusion dosages and injection time intervals, and the required the patient to remain bound to the hospital bed during prolonged infusion periods. Improved infusion pump systems employ a programmed pump have that can automatically infuse preset volumes of fluid into the patient on a predetermined schedule, thus relieving medical personnel from constant monitoring of the patient and infusion amounts and timetables. These fluid infusion pump systems generally include a programmable pump and a fluid delivery set comprising a fluid container, tubing, pinch clamp, drip chamber, etc., all connected as an integral unit. The fluid container, which holds the fluid for delivery, may be a flexible bag, a rigid glass or plastic bottle or a burette.

The use of infusion pumps has enabled the development of compact and portable infusion pump systems that can provide ambulatory continuous infusion therapy over an extended time. Portable infusion pumps can, for example, be worn on a belt around the patient's waist or on a shoulder harness. Nevertheless, as with current portable oxygen concentrators, the currently available portable fluid delivery systems also do not necessarily provide patients with the ease of mobility that they desire.

Typically, both portable oxygen concentrators and portable infusion pumps (as well as other portable medical device products), are singularly packaged and employ cases specifically designed to be carried in some fashion (typically, “over the shoulder”). While providing patients with some improvement in terms of mobility, these products are still generally limiting in terms of maneuverability, particularly in terms of the patient's ability to tote other commonly used and transported items and accessories (for example, wallets, purses, cellular telephones, planners, portable music players, work bags, gear bags, carryon-bags, etc.). This is especially a concern for more active patients that intend to conduct their daily activities in the same manner as they did prior to requiring the treatment provided by the device, as well as other mobile patients that are required to use and therefore carry multiple portable medical device products along with the accompanying appendages for those devices.

### SUMMARY

Exemplary embodiments of the present invention are related to an apparatus for operatively carrying and providing ready access to the operation of a portable oxygen concentration module. The apparatus comprises a carrying case having a hollow body portion defining a first inner chamber therein, a lower end configured to stabilize the carrying case in an upright position when the carrying case is rested on a generally planar surface, and an upper end defining a primary opening to the first inner chamber. The primary opening is sized and configured to permit the oxygen concentration module to be deposited into the first inner chamber therethrough. The first inner chamber is sized and configured to receive and operatively retain the oxygen concentration module therein. The apparatus further comprises a plurality of intake vents integrated within the hollow body portion, a plurality of exhaust vents integrated within the hollow body portion, and a first aperture integrated within the carrying case. The intake vents are positioned to align with inlet vents of the oxygen concentration module when the oxygen concentration module is received within the first inner chamber to permit ambient air to be drawn into the oxygen concentration module from a surrounding atmosphere. The exhaust vents are positioned to align with outlet vents of the oxygen concentration module when the oxygen concentration module is received within the first inner chamber to permit exhaust gas to be vented from the oxygen concentration module to the surrounding atmosphere. The first aperture is positioned to align with an outlet port of the oxygen concentration module when the oxygen concentration module is received within the first inner chamber to allow attachment of an oxygen delivery tube to the outlet port of the oxygen concentration module.

Exemplary embodiments of the present invention are also related to a modular cart system for operatively transporting a carrying case for a portable oxygen concentration module and a portable infusion pump module. The modular cart system comprises a base platform horizontally extending from a first end to a second end, a handle portion attached to the first end of the base platform, one or more rolling elements attached to the first end of the base platform, and a case operatively supported by the base platform and having a generally rectangular cross-section. The handle portion has a pair of telescoping rails extending vertically upward to a crossbar portion. The telescoping rails are configured to extend to and releasably lock in an upper extended position. The telescoping rails are configured to retract to and releasably lock in a lower retracted position. The one or more rolling elements are configured to operate in conjunction with the base platform stabilize the carrying case in an upright position when the carrying case is rested on a generally planar surface. The one or more rolling elements are configured to facilitate rolling movement of the modular cart system over a ground surface upon tilting of the base platform and the handle portion to a movable position and application of lateral force to the handle portion. The case has an upper panel. The upper panel has a substantially arcuate support portion adjacent to the telescoping rails of the handle portion. The support portion is sized and configured to receive the carrying case for the oxygen concentration module and to operate in conjunction with the telescoping rails to retain the carrying case. The case provides a first inner compartment sized and configured to receive and operatively retain the infusion pump module therein.

The above-described and other features of the present disclosure will be appreciated and understood by those skilled in the art from the following detailed description, drawings, and appended claims.

### BRIEF DESCRIPTION OF THE DRAWINGS

FIGS. 1a-1d are front, top perspective, and rear views of an exemplary embodiment of a carrying case for an oxygen concentration system in accordance with the present invention;

FIGS. 2a-2c are front, side, and top perspective views of an exemplary portable oxygen concentration system for which exemplary embodiments of the present invention can be configured;

FIGS. 3a and 3b are front views of alternative exemplary embodiments of carrying cases for a portable oxygen concentration module in accordance with the present invention;

FIGS. 4a and 4b are side and front views respectively of an exemplary embodiment of a mobility cart in accordance with the present invention;

FIG. 5 is a partial, left-side perspective view of an exemplary embodiment of a mobility cart in accordance with the present invention;

FIGS. 6a-6e are right-side views illustrating a process of converting an exemplary mobility cart into a more compact form in accordance with an exemplary embodiment of the present invention; and

FIGS. 7a and 7b are side perspective views respectively of an exemplary embodiment of a mobility cart with a removably secured carrying case in accordance with the present invention.

### DESCRIPTION OF EXEMPLARY EMBODIMENTS

In the following detailed description, reference is made to the accompanying drawings that form a part hereof, and in which is shown by way of illustration, exemplary embodiments of the present invention. These exemplary embodiments are described herein in sufficient detail to enable those skilled in the art to practice the present invention, and it is to be understood that other embodiments may be utilized and that structural changes may be made to the described exemplary embodiments without departing from the scope of the present invention. It should also be noted that terms of orientation and direction such as top, bottom, front, rear, etc. as used herein are used to distinguish elements from one another within exemplary embodiments and should therefore not be taken as limiting the scope of the present invention to any specific orientation. Moreover, the use of the terms first, second, etc. do not denote any order or importance, but rather are used to distinguish one element from another. Furthermore, the use of the terms a, an, etc. do not denote a limitation of quantity, but rather denote the presence of at least one of the referenced item. Therefore, the following detailed description and accompanying drawings are not to be taken in a limiting sense, and the scope of the present invention is defined by the appended claims and their equivalents.

Exemplary embodiments of the present invention are directed to a mobile, modular case and cart system offering the flexibility to receive and operatively dock both a portable oxygen concentration module and a portable infusion pump module. Exemplary embodiments can also be implemented to provide additional consumer driven storage and functionality features, such as by providing additional flexibility for carrying other portable medical devices, administration sets, and other appendages for the portable medical devices, as well as personal items and accessories. Exemplary embodiments can be implemented to provide flexible, modular design that enables a variety of usage scenarios to increase mobility and maneuverability for patients that require oxygen and/or intravenous drug therapy yet still wish to lead an active life, such as by conducting daily activities like work, traveling, and shopping that require moving in and out of various environments and situations.

Different exemplary embodiments of the present invention can be configured according to the specific designs and configurations of the cases for particular portable oxygen concentrator products and/or portable infusion pump products so as to be able to receive and operatively dock the particular devices, as well as their corresponding appendages and accessories. Thus, while the exemplary embodiments provided herein will be described with reference to specific designs of portable oxygen concentrator products and portable infusion pump products illustrated in the accompanying drawings and described herein, it should be appreciated that the embodiments provided herein are exemplary only and therefore should be considered non-limiting, and further, that alternative exemplary embodiments of the present invention can be configured according to the specific designs and configurations of various other particular portable oxygen concentrator products and/or portable infusion pump products.

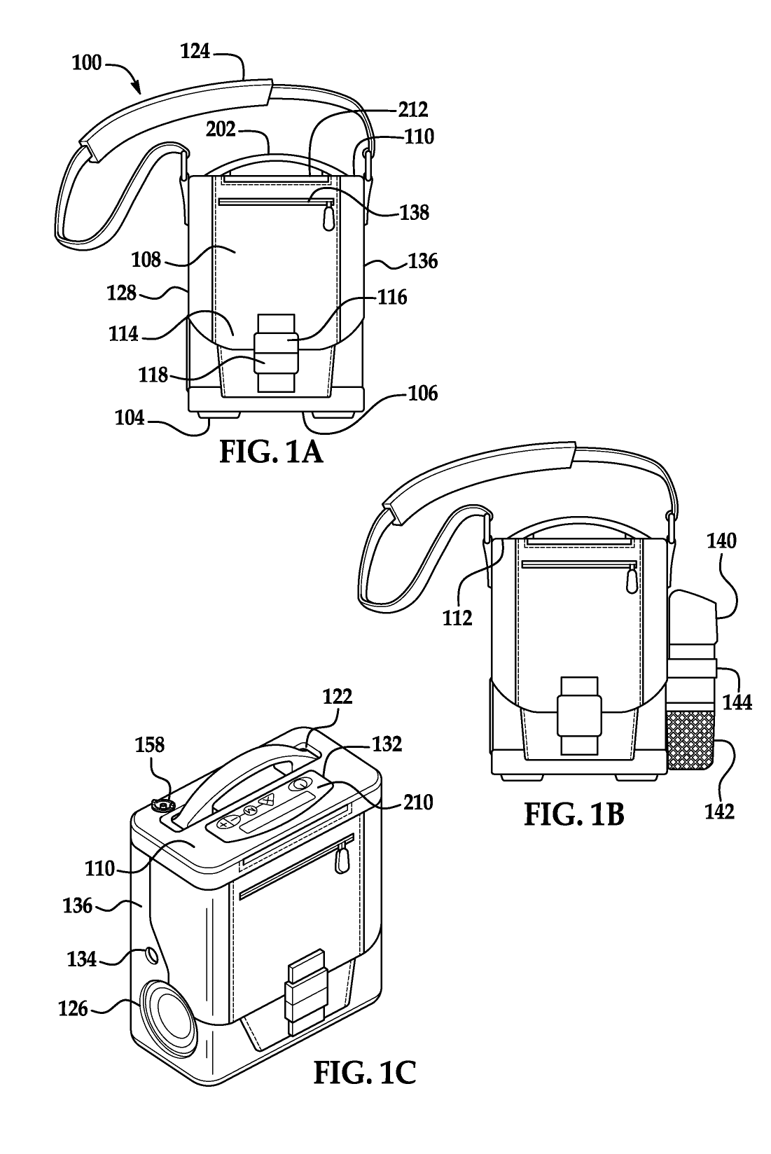

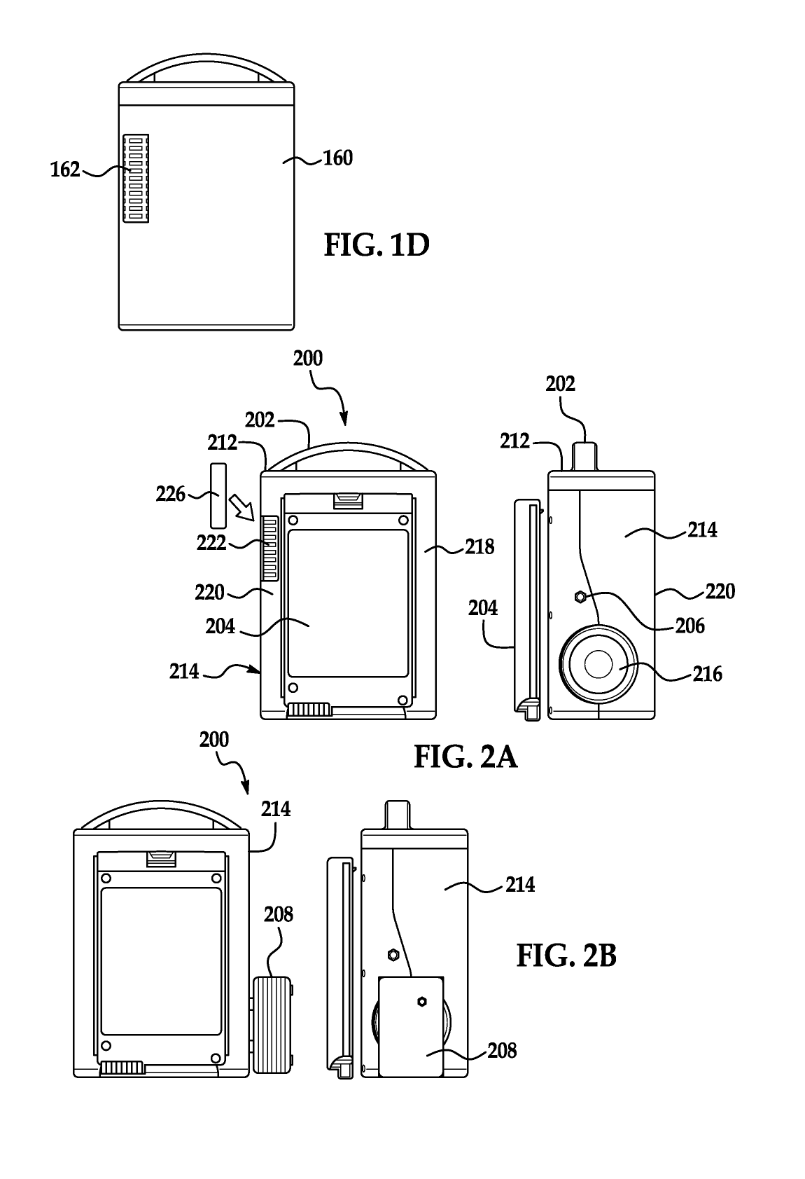

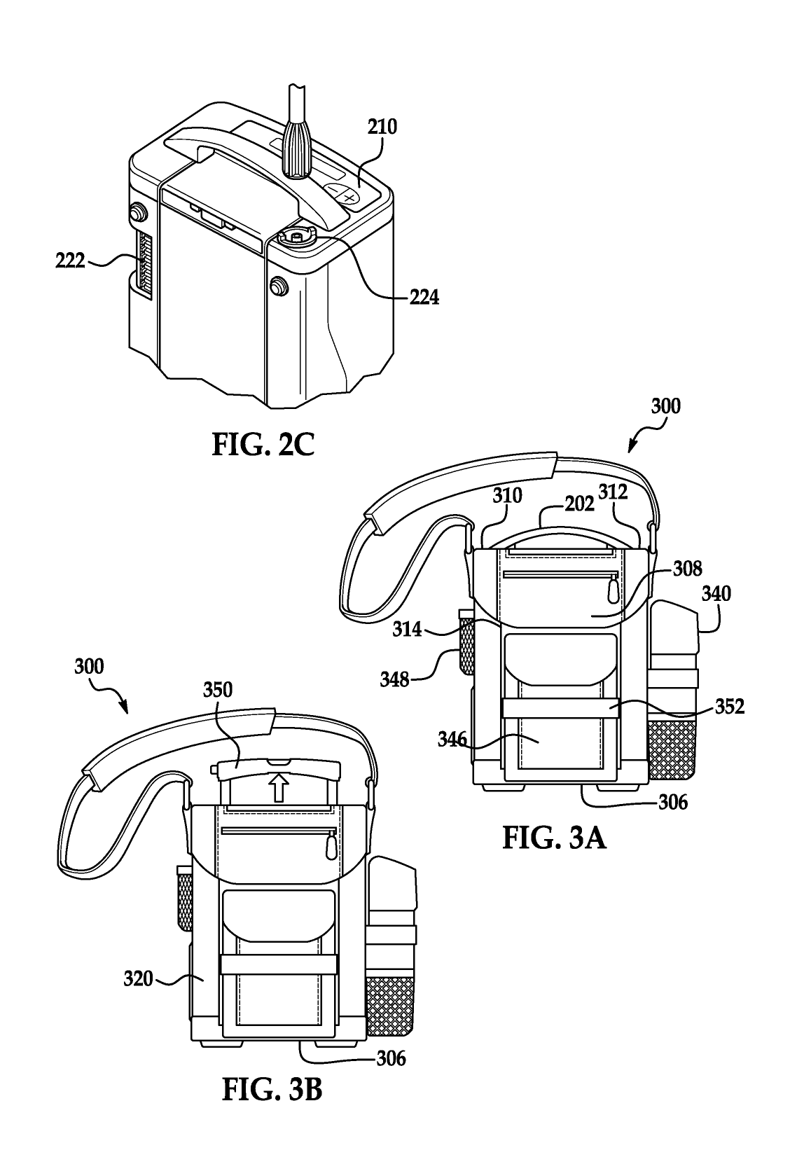

In accordance with an exemplary embodiment of the present invention, FIGS. 1a-1d illustrate a carrying case configured to receive and dock an exemplary portable oxygen concentration module. The carrying case is indicated generally by reference numeral 100 in FIGS. 1a-1d. FIGS. 2a-2c provide various views illustrating the design of the particular exemplary portable oxygen concentration module, indicated generally by reference numeral 200, according to which the carrying case of FIGS. 1a-1d is configured. For better appreciation of the various functionalities and features that will be described herein as being provided by carrying case 100, the operation and the components of oxygen concentration module 200 will first be described.

Oxygen concentration module 200 is an example of a portable, small implementation of such a system that may utilize, for example, a pressure swing absorption (PSA) process (or, alternatively, a VPSA process, a rapid PSA process, a very rapid PSA process, etc.) to separate oxygen from the ambient air around a patient employing the oxygen concentration module for oxygen therapy. Oxygen concentration module 200 is capable of pulsed or continuous delivery of oxygen at substantially higher concentrations than that of ambient air and is also capable of delivering the product stream of gas at specific and variable intervals upon demand by a patient. Oxygen concentration module 200 is designed to be portable and lightweight so as to permit ambulatory movement of the patient and can, for example, produce a product stream of gas at a flow rate of up to approximately five liters per minute (LPM) at concentrations anywhere from fifty to ninety-five percent oxygen.

Oxygen concentration module 200 includes a housing 220 and a handle 202 mounted on a top end 212 of the housing that can be used for carrying the portable oxygen concentration module. Housing 220 may be formed from a substantially rigid material such as plastic (for example, acrylonitrile butadiene styrene (“ABS”), polycarbonate, and the like), metal, (fore example, aluminum), or composite materials. Housing 220 may enclose, generally, an air separation device (not shown) such as an oxygen gas generator that separates concentrated oxygen gas from ambient air, one or more output sensors (not shown) used to sense one or more conditions of the patient or the environment (such as flow rate, oxygen concentration level, etc.) to determine the oxygen output needed by the patient or required from the oxygen concentration module, and a control unit (not shown).

The air separation device of oxygen concentration module 200 may include, generally, a pump such as a compressor and an oxygen concentrator, which may be integrated within the air separation device. During operation of module 200, ambient air may be drawn into housing 220 through a replaceable filter element 226 and a plurality of inlet vents 222 on a rear side 218 of the housing and then through an integrated inlet muffler to the air separation device by action of the compressor. Oxygen concentration module 200 then separates oxygen gas from the intake air for eventual delivery to the patient. Gas can ultimately be delivered from oxygen concentration module 200 to the patient using an oxygen delivery tube (not shown), which can be a polymer tube or similar oxidation resistant structure that is configured to be attached to and extend from an outlet port 224 of housing 220 to the nose, mouth, or other port into the upper airway of the patient.

The oxygen concentrator has internal functions based around a pair of sieve beds that each has an air inlet/outlet end and an oxygen inlet/outlet end. Each sieve bed is filled with a molecular sieve containing tiny pores of zeolite material. Generally, to generate concentrated oxygen, the oxygen concentrator is operated such that the sieve beds are alternatively “charged” and “purged”, as will now be described. During operation, the oxygen concentrator directs the pressurized airflow through one of the sieve beds, where the zeolite material, which strongly attracts nitrogen molecules while allowing oxygen molecules to pass through when under pressure, selectively adsorbs the nitrogen in the intake air. Once the intake air has passed through the one sieve bed, the nitrogen and most other impurities have been removed, and essentially all that remains is concentrated oxygen with trace amounts of inert argon. The residual concentrated oxygen can then flow through a pressure-reducing orifice, and then through a supply line from the concentrator for eventual delivery through the delivery tube to a patient, completing one cycle of the oxygen concentrator.

The nitrogen that is left adsorbed in the zeolite material must then be removed. During each cycle of the oxygen concentrator, while one of the sieve beds is pressurizing, pressure in the other sieve bed is reduced to approximately zero to allow the zeolite material to purge its adsorbed nitrogen. The exhaust gas then exits oxygen concentration module 200 through an exhaust 216 having a muffler integrated with vents opening through a first side 214 of housing 220 for venting to the atmosphere. Then, to regenerate the purged zeolite material, this other sieve bed can, for example, be subjected to a pressure change or brought under heat from a vacuum generator to regenerate the zeolite.

When this is complete, the cycle reverses (for example, every five to ten seconds), and the newly regenerated sieve bed pressurizes and produces oxygen while the other sieve bed is purged and regenerated. In this manner, each of the sieve beds is alternately adsorbing and purging, and during each cycle, intake air is flowed through one sieve bed where the nitrogen molecules are captured by the zeolite, while the other sieve bed is vented off to ambient atmospheric pressure to allow the captured nitrogen to dissipate. Oxygen concentration module 200 is thereby able to produce a pulsed or continuous supply of concentrated oxygen.

The air separation device of oxygen concentration module 200 can be powered by an energy source such as a plug configured to allow the oxygen concentration module to be powered from a DC power source and/or an AC power source, a rechargeable battery (for example, of the lithium-ion type), a battery pack, or a rechargeable or renewable fuel cell that powers at least a portion of the air separation device. For example, as depicted in FIGS. 2a-2c, oxygen concentration module 200 is configured to be powered either from a battery pack 204 or from a power adapter through an adapter input terminal 206 located on first side 214 of housing 220. Thus, as illustrated in FIGS. 2a-2c, oxygen concentration module 200 can be provided with a power adapter 208 that is connectable to adapter input terminal 206 and that can be configured to plug into a DC power source and/or an AC power source to supply power to the oxygen concentration module through the adapter input. The compressor may, for example, be driven by a motor that runs off of electrical current supplied by the energy source.

The control unit of oxygen concentration module 200 is linked to the output sensor(s), the air separation device, and the energy source to control the operation of the air separation device in response to the one or more conditions sensed by the output sensor(s). Oxygen concentration module 200 may also provide a user interface as part of or coupled to the control unit through which the patient, provider, doctor, etc. can input information such as prescription oxygen level, flow rate, patient activity level, etc., to control the oxygen output of the oxygen concentration module. In alternative exemplary embodiments, oxygen concentration module 200 may not include output sensor(s) coupled to the control unit. Instead, in these embodiments, the conditions of oxygen concentration module 200 may be constant for the module or may be manually controllable through the user interface.

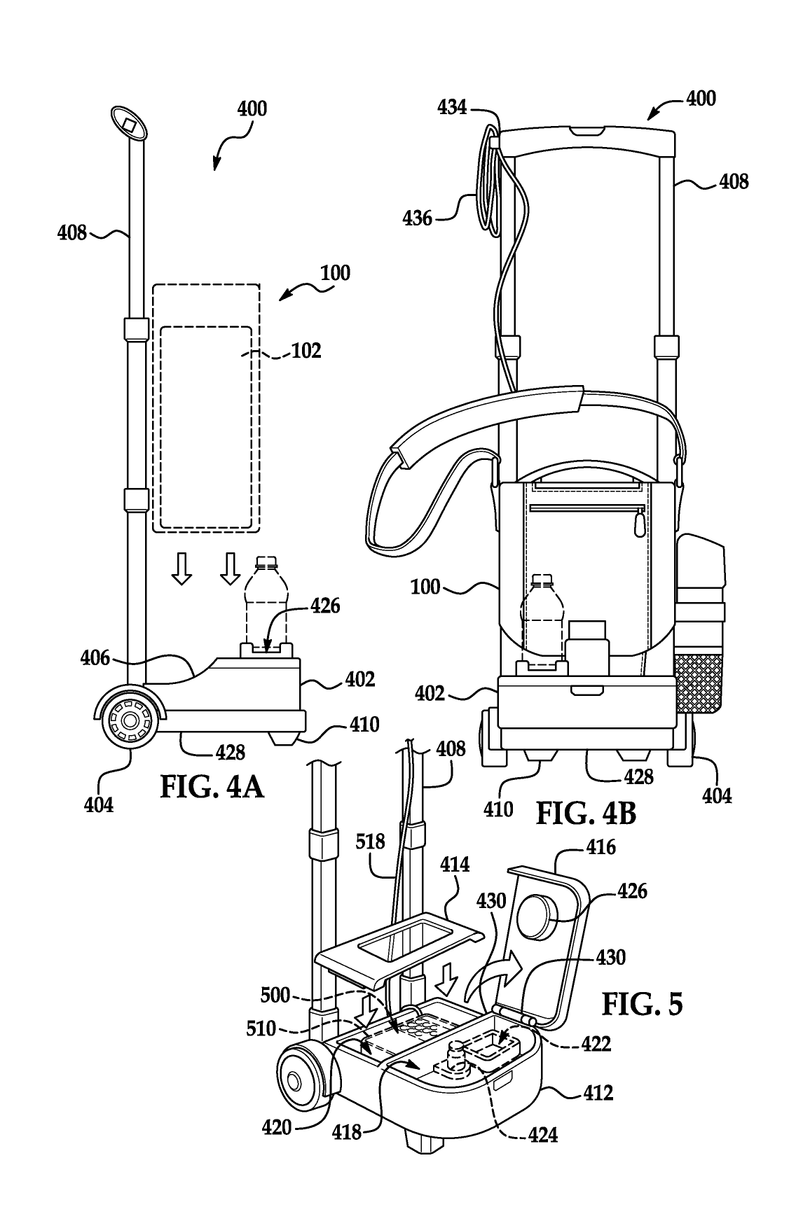

Referring again to the exemplary embodiment illustrated in FIG. 1a, carrying case 100 is provided with a small and lightweight, generally rectangular configuration for receiving and operatively retaining portable oxygen concentration module 200 therein. More specifically, carrying case 100 includes a primary inner chamber 102 (shown in dotted line in FIG. 4a, which is described below) formed within the carrying case that is configured according to the design of housing 202 of module 200 to slidably receive and encapsulate the housing therein. Of course, as discussed above, the present exemplary embodiment is non-limiting, and it should be appreciated that carrying case 100 and primary inner chamber 102 can be configured in various different shapes and sizes to accommodate various different types and designs of portable oxygen concentration modules. For example, carrying case 100 may have an elliptical, square, cylindrical, or other regular or irregular polygonal shape, which may be determined based upon spatial, performance, structural, and/or other criteria.

In exemplary embodiments, carrying case 100 can be constructed from one or more lightweight and flexible materials that are also sufficiently rigid such as leather, canvas, netting, elastic, or nylon materials. Exemplary embodiments of carrying case 100 can also comprise a trilaminate construction. All edges of carrying case 100 can be hemmed or edge seamed by a simple stitch pattern to prevent unraveling. The edges of carrying case 100 can be contoured to provide for comfortable handling. Carrying case 100 is further provided with feet 104 projecting from a bottom end 106 of the carrying case. Feet 104 can comprise an elastic polymer such as rubber to provide sufficient frictional and balancing forces to enable carrying case 100 to be securely rested in an upright position on a generally planar surface when not being carried or during loading of oxygen concentration module 200 therein.

In exemplary embodiments, interior walls of carrying case 100 can be provided with lining to provide for sound damping of noise induced by the oxygen concentration module 200. The lining can be made from a foam material such as, for example, polyurethane foam (foam rubber), Styrofoam, or some other manufactured foam. In exemplary embodiments in which carrying case 100 is configured according to the design of a particular oxygen concentration module that is constructed to incorporate a sound-damping means within the module, the interior walls of the carrying case 100 may be provided without a sound damping lining.

Carrying case 100 is provided with a front flap 108 that includes a first end 112 and a second end 114, and extends from the rear side of a top end 110 of the carrying case. First end 112 of front flap 108 is hemmed or edge seamed to the rear side of a top end 110 of the carrying case. A first fastener member 116 is attached to second end 114 of front flap 108. As depicted in FIG. 1a, front flap 108 is configured to close carrying case 100 and thereby securely hold the oxygen concentration module therewithin by folding over top end 110 of the carrying case such that first fastener member 116 able to latch in releasable engagement with a corresponding second fastener member 118 that is attached to a front side 120 of the carrying case proximate to bottom end 106. Fastener members 116, 118 can comprise, for example, clips, zippers, or eyelets.

Furthermore, carrying case 100 is adapted not only so that oxygen concentration module 200 can be transported therein, but also so that the module can be operated to provide oxygen therapy to a patient while oxygen concentration module 200 is retained within the carrying case. The configuration of carrying case 100 allows for oxygen concentration module 200 to be used to oxygen therapy to the patient at home, at the office, in the automobile, etc. without requiring removal of the module from the carrying case. Furthermore, the configuration of carrying case 100 also allows the patient, while being administered oxygen therapy, to move from one location to another without interruption of the oxygen therapy. For example, when the patient goes from one room to another room, the patient can simply transport both carrying case 100 and module 200 using, for example, handle 202 and walk into the other room while the module continuously operates under battery power.

Front flap 108 is configured with an aperture 122 that extends laterally across top end 110 of carrying case 100 when the front flap is folded over the top end to close the carrying case as described above. Aperture 122 is formed in front flap 108 so that, when oxygen concentration module 200 is received within carrying case 100, handle 202 can project from top end 110 of carrying case 100 through the aperture and thereby allow for the portable oxygen concentration module and the carrying case to be easily carried as a single, stable unit using the handle. Front flap 108 is also configured with an outlet tube aperture 158 that corresponds to outlet port 224 of oxygen concentration module 200 when the front flap is folded over the top end to close the carrying case as described above. Aperture 158 is formed in front flap 108 so that, when oxygen concentration module 200 is received within carrying case 100, an outlet port 224 on top end 212 of the oxygen concentration module is accessible from top end 110 of carrying case 100 through the aperture to allow for an oxygen delivery tube to be attached to the portable oxygen concentration module and thereby allow the module to be operated to provide for oxygen delivery to a patient while disposed within the carrying case.

In the present exemplary embodiment, in which carrying case 100 is configured according to an oxygen concentration module that provides a user interface 210 accessible at top end 212 of the module as part of or coupled to the control unit through which information can be input to control the oxygen output of the oxygen concentration module, front flap 108 is also configured with a second aperture 132 that extends laterally across top end 110 of carrying case 100 when the front flap is folded over the top end to close the carrying case. When front flap 108 is in the closed position, second aperture 132 can provide access to user interface 210 while the oxygen concentration module is retained within the carrying case. In exemplary embodiments, carrying case 100 can be configured so that apertures 122 and 132 are combined into a single aperture that extends laterally across top end 110 to allow handle to project from top end 212 as well as provide access to the user interface.

In the present exemplary embodiment, a first side 128 of carrying case 100 includes an exhaust aperture 126 and a rear side 160 of the carrying case includes a plurality of intake vents 162. Intake vents 126 are positioned to align with inlet vents 222 on rear side 218 of housing 220 of oxygen concentration module 200 so that ambient air can be drawn through both sets of vents into the housing and then through the inlet muffler to the air separation device by action of the compressor during operation of the oxygen concentration module. Exhaust aperture 216 is positioned to align with exhaust on first side 214 of housing 220 of the oxygen concentration module to allow for exhaust gas exiting oxygen concentration module 200 to be vented to the atmosphere and regeneration of the zeolite material in the sieve beds. Intake vents 126 can be made of, for example, a special permeable polyester material that provides for even air distribution.

In the present exemplary embodiment, carrying case 100 is also provided with a power line aperture 134 through a first side 128 that is positioned to align with adapter input terminal 206 on first side 214 of housing 220 when oxygen concentration module 200 is received within the carrying case. Power line aperture 134 allows for power adapter 208 to be connected to adapter input 206 through the carrying case, thereby allowing oxygen concentration module 200 to be powered by a DC power source and/or an AC power source without requiring removal of the module from carrying case 100. In addition, where power adapter 208 includes battery-charging circuitry, power line aperture 134 allows for battery pack 204 to be charged by the power source while module 200 is not being operated or simultaneously with the module being powered by the power source or the battery pack while operating.

In the present exemplary embodiment, carrying case 100 also includes a padded shoulder strap 124 that allows the case to be readily lifted and comfortably carried, and thereby allows the oxygen concentration module, when deposited in the carrying case as described above, to be easily transported. In alternative exemplary embodiments, carrying case 100 can be provided with strap(s) that allow the case to be transported as a backpack, a fanny pack, a front pack, etc. The strap(s) can be removably secured to carrying case 100 using as suitable combination of fastener members (for example, a belt buckle and holes or like fastening device) and/or hooks, or the strap(s) can be permanently affixed to the carrying case. If it remains too difficult for a particular patient to carry the oxygen concentration module within carrying case 100 using the features provided for by the carrying case, the carrying case may be readily transported to the destination using, for example, exemplary embodiments of the mobility cart described with reference to FIGS. 4a and 4b in greater detail below, or another suitable transporting apparatus.

In exemplary embodiments, carrying case 100 can also be further configured to provide for the ability to tote additional items such as administration sets, appendages for the oxygen concentration system, and other commonly used and transported items and accessories (for example, wallets, purses, cellular telephones, planners, portable music players, work bags, gear bags, carryon-bags, etc.). For example, as depicted in FIG. 1a, carrying case 100 also includes a front pocket 138 provided within front flap 108 that can be used to retain and carry, for example, personal items and other accessories for oxygen concentration module 200 such as a spare battery pack for powering the module. Front pocket 138 is openable and closable by a zipper fastener.

As another example, as depicted in the alternative exemplary embodiment illustrated in FIG. 1b, carrying case 100 can be provided with a modular configuration that includes a removable side pocket accessory or module 140 that is attachable to and detachable from a second side 136 of the carrying case. More specifically, carrying case 100 includes a side strap 144 that is configured to receive and removably retain side pocket accessory 140 therewithin. Side pocket accessory 140 can be used to retain and carry, for example, personal items and other accessories and appendages for oxygen concentration module 200 such as power adapter 208. In alternative exemplary embodiments, side pocket accessory 140 could be attached to and detachable from first side 128, and provided with a first aperture allowing for power adapter 208 to be retained with the side pocket accessory while connected to adapter input 206 of oxygen concentration module 200 through power line aperture 134 of the carrying case, and a second aperture allowing the power adapter to be retained with the side pocket accessory while a power cord extends through the second aperture to plug into a DC power source and/or an AC power source to supply power to the oxygen concentration module. By providing the patient with storage to hold a power adapter that includes battery-charging circuitry and a spare battery pack, carrying case 100 can allow the patient to always have a freshly charged battery pack on hand for powering the oxygen concentration module 200. With a freshly charged battery for module 200 available, the patient's excursions outside the home, office, etc. while oxygen therapy is being administered can be conducted in the same easy manner as going from room to room, as described above, without interruption of the treatment.

In the present exemplary embodiment, side pocket accessory 140 is removable to allow carrying case 100 to be transported more compactly without the additional side pocket accessory and also to allow the side pocket accessory to be used as a separate case. Side pocket accessory 140 can also be provided in various configurations that provide additional storage space such as, for example, a configuration that includes a webbed pocket 142, as illustrated in FIG. 1b.

Referring now to FIG. 3a, an alternative exemplary embodiment of a carrying case 300 that is configured for receiving and operatively retaining portable oxygen concentration module 200 therein. Carrying case 300 is configured in a similar fashion to carrying case 100 of FIGS. 1a-1d and is provided with a removable side pocket accessory 340 attached thereto, but also provides a modified configuration having increased modularity to provide for a greater amount of storage space that can be used to retain and carry, for example, personal items and other accessories for oxygen concentration module 200.

In particular, as with carrying case 100 depicted in FIGS. 1a-1d, carrying case 300, as shown in FIG. 3a, is provided with a front flap 308 that extends from a first end 312 at the rear side of a top end 310 of the carrying case to a second end 314, and the front flap is configured to close carrying case 300 and thereby securely hold the oxygen concentration module therewithin by folding over top end 310 of the carrying case. In the present exemplary embodiment, however, the length of front flap 308 is truncated, such that second end 314 of the front flap is more proximate to top end 310 of carrying case 300 than bottom end 306 when the front flap is folded over the top end to close the carrying case. To close carrying case 300, front flap 308 engages a front side 320 of the carrying case. As with front flap 108 of exemplary carrying case 100 described above, front flap 308 can be configured with an aperture that extends laterally across top end 310 of carrying case 300 when the front flap is folded over the top end to close the carrying case so that, when oxygen concentration module 200 is received within carrying case 300, handle 202 can project from the top end of the carrying case through the aperture; an outlet tube aperture that corresponds to outlet port 224 of oxygen concentration module 200 when the front flap is folded over top end 310 of carrying case 300 so that the outlet port is accessible from the top end of the carrying case to allow for an oxygen delivery tube to be attached to the portable oxygen concentration module; and a second aperture that extends laterally across top end 310 of carrying case 300 when the front flap is folded over the top end of the carrying case to provide access to user interface 210 while the oxygen concentration module is retained within the carrying case. These apertures can thereby allow for portable oxygen concentration module 200 and carrying case 300 to be easily carried and operated as a single, stable unit using the handle when the carrying case is closed as described above.

By providing carrying case 300 with front flap 308 in its shortened form, carrying case 300 can be configured with increased modularity. As shown in FIG. 3a, carrying case 300 includes a front pocket accessory 346 that is attachable to and detachable from a front strap 352 on front side 320 of the carrying case. Front strap 352 is configured to receive and removably retain front pocket accessory 346 therewithin. Front pocket accessory 346 can be used to retain and carry, for example, personal items and other accessories for oxygen concentration module 200 such as a spare battery pack. Front pocket accessory 346 is removable to allow carrying case 300 to be transported in a more compact and lightweight manner and also to allow the side pocket accessory to be used as a separate case. As illustrated in FIG. 3a, carrying case 300 can also be configured to provide other storage space options such as, for example, one or more additional webbed pocket(s) 348. In exemplary embodiments, the additional storage options provided by carrying case 300 can be specifically configured to receive and retainably carry accessories for oxygen concentration module 200 such as, for example, a spare battery pack, a power adapter, and/or any tubing or lines that maybe associated with the module.

A carrying case in accordance with exemplary embodiments of the present invention can also include hooks, straps, and/or holders configured to securely attach to one or more modes of transportation, and thereby allow an oxygen concentration module for which the carrying case is configured to be easily transported with the carrying case when retained therein. Examples of hooks, straps, and holders provided by a carrying case can include, but not by way of limitation, hooks for seatbelts in cars, hooks/straps for walkers, hooks/straps for wheel chairs, hooks/straps for hospital beds, hooks for other medical devices such as ventilators, hooks/straps for a golf bag or golf cart, hooks/straps for a bicycle, and a hanging hook. Furthermore, as depicted in the alternative exemplary embodiment illustrated in FIG. 3b, carrying case 300 can be provided with a telescoping handle 350 and rolling elements (for example, casters or wheels) attached to bottom end 306 of the carrying case that allow for the carrying case to be transported with the oxygen concentration module as a rolling trolley/cart by application of manual pushing or pulling force to activate the rolling elements. Telescoping handle 350 may either by permanently or removable and demountably attached to the rear side of carrying case 300.

Referring now to FIGS. 4a and 4b, an exemplary embodiment of a modular and customizable mobility cart 400 configured to be utilized for transporting carrying case 100 of FIGS. 1a-1d (or, alternatively, carrying case 300 of FIGS. 3a and 3b). Mobility cart 400 can thereby be utilized by patients traveling away from home for transporting oxygen concentration module 200 of FIGS. 2a-2c using carrying case 100 (as depicted by the dotted line in FIG. 4a) or carrying case 300. As will be described, mobility cart 400 is implemented as a convertible, multi-purpose cart that can interchangeably function as a movable transport device or a stationary administration device in various forms, and can be easily converted from one use mode to another. Mobility cart 400 can be easily assembled or disassembled by connecting its parts together, or optionally assembled from a pre-set storage configuration in a carry pack to an assembled structure.

As depicted in FIGS. 4a and 4b, mobility cart 400 includes a partial, generally rectangular case 402, a base platform 428 attached to a pair of rolling elements (for example, casters or wheels) 404 and extending horizontally forward, and a handle portion 408 extending vertically upward from the base platform to a crossbar for users to hold when moving mobility cart 400. Handle 408 has two nested, telescoping rails that can be extended and retracted. Handle 408 is configured to lock in an extended position for hauling mobility cart 400 and to retract to a lower position for stationary use and storage. Rolling elements 404 engage the ground to facilitate rolling movement of mobility cart 400 over the ground upon tilting of the cart to a movable position and application of manual pushing or pulling force to actuate rolling elements 404. Base platform 428 is configured to support case 402 and also includes a pair of legs 410 for balancing and stabilizing mobility cart 400 in an upright position when it is stationary. That is, mobility cart 400 can remain upright with a center of gravity between the pair of rolling elements 404 and the pair of legs 410. Base platform can comprise any sufficiently strong, rigid, and lightweight material such as polymer plastic, wood, metal alloy, etc.

As also shown in FIG. 4a, case 402 has a substantially arcuate support portion 406 adapted for receiving and retaining carrying case 100. FIG. 4b illustrates the manner in which carrying case 100 is positioned and retained in support portion 406 of mobility cart 400. By providing for carrying case 100 to be positioned in this manner, mobility cart 400 allows for unobstructed fluid communication between the surrounding atmosphere and the intake and exhaust vents of the carrying case, and thereby between the surrounding atmosphere and the inlet and outlet vents of oxygen concentration module 200. Case 402 can be formed of rigid polymeric material such as an acrylic or an ABS, or any other suitable lightweight but resilient material such as wood, metal alloy like stainless steel, etc. At least some of structures of case 402 and base platform 428 can be integrally formed via an injection molding process so as to ensure dimensional accuracy. Although case 402 is shown as having a generally rectangular shape in the present exemplary embodiment, it will be appreciated that in alternative exemplary embodiments, the case may have other desired shapes, which may be determined based upon spatial, performance, structural, and/or other criteria. For example, case 402 may have an elliptical, square, cylindrical, or other regular or irregular polygonal shaped cross-section.

Case 402 of mobility cart 400 is illustrated in greater detail in FIG. 5. Case 402 includes a body portion 412, a cover portion 416, and a detachable lid portion 414. As shown in FIG. 5, cover portion 416 is coupled to a first hinge 415 at an end of body portion 412 and thereby configured to rotate about the first hinge to an open position that provides access to a first inner compartment 418. In exemplary embodiments, first hinge 415 can comprise any suitable type of hinged joint structure that can provide for rotational motion such as, for example, a pivot joint, stiffened, flexible wire, or a swivel joint.

In the present exemplary embodiment, first inner compartment 418 includes at least one slot 424 configured to receive and retain a prescription medication bottle and a chamber 422 that can be used to retain and carry personal items and other medical accessories. For example, chamber 422 can be used to retain and carry a travel first aid kit. Chamber 402 may also be provided with enough room for carrying items such as extra batteries, a power adapter, fluid and/or oxygen delivery tubes, etc. In the present exemplary embodiment, as shown in FIGS. 4a, 4b, and 5, cover portion 416 is also provided with a cavity 426 formed therein that can accommodate, for example, a beverage. Lid portion 414, which includes support portion 406, is removable to provide access to a second inner compartment 420 that is separated from first inner compartment 418 within case 402 by a wall 430. In the present exemplary embodiment, second inner compartment 420 is configured according to the design and configuration of a particular portable infusion pump module to receive and securely retain the portable infusion pump module therein, as will be described in greater detail below. Inner compartments 418, 420 can include foam lining on their respective inner surfaces for limiting the movement of contents retaining therein.

It should be noted that the present exemplary embodiment of mobility cart 400 should be considered to be non-limiting, and in different exemplary embodiments, case 402 can be provided with varying shapes, sizes, and numbers of compartments, chambers, lids, covers, trays, drawers, etc. to provide flexibility for suitably addressing needs to transport variable medical equipment, medical accessories, and personal items as these needs evolve and/or become required. For example, in various alternative embodiments, case 402 can be configured for transporting a variety of medical treatment equipment, from at least first aid equipment to more sophisticated equipment such as utility power sources, diagnostic equipment, one or more liquid and/or gaseous fluid sources, medical surgical accessories, such as trays, lamps, arm rests and stirrups, and/or other containers with medical supplies therein. Thus, mobility cart 400 can be configured to provide a single, compact unit in which any number and combination of appendages and accessories for an oxygen concentration module and an infusion pump module (as well as any number and combination of personal items) can be transported therein, thereby affording patients greater ease of mobility when traveling.

In exemplary embodiments, mobility cart 400 can be configured such that body portion 412 of case 402 is completely detachable from base platform 428 so that the body portion can be transported individually and separately from the trolley portion of the cart. In alternative exemplary embodiments, case 402 can be provided with strap(s) that allow the case to be transported as a backpack, a shoulder pack, a fanny pack, a front pack, etc. The strap(s) can be removably secured to case 402 using a suitable combination of fastener members (for example, a belt buckle and holes or like fastening device) and/or hooks, or the strap(s) can be permanently affixed to the case. Furthermore, mobility cart 400 can be configured such that body portion 412, when detached from base platform 428, is attachable to handle 408 so that is can be mounted in an upright position on the side of the handle opposite the base platform. This can allow for carrying case 100 to be retained in support portion 406 and, thus, for oxygen concentration module 200 to be operated from this position when such a position affords greater accessibility to the module. Mobility cart 400 thus provides a modular transport system that affords a single person a variety of options to easily transport both a portable oxygen concentration module and a portable infusion pump module for ambulatory use by a patient.

In exemplary embodiments, case 402 of mobility cart 400 may have a built-in power adapter including battery charging circuitry and one or more plugs configured to allow oxygen concentration module 200 and/or and portable infusion pump to be powered from a DC power source (for example, car cigarette lighter adapter) and/or an AC power source (for example, home or office VAC wall socket) while the battery is simultaneously being charged from the DC or AC power source. In this fashion, mobility cart 400 can be configured so as to obviate the need for users to pack power supplies or external chargers when traveling with oxygen concentration module 200. The adapter or charger could also be a separate accessory. For example, the adapter may be a separate cigarette lighter adapter used to power module 200 and/or charge a battery for the module in an automobile. A separate AC adapter may be used to convert the AC from an outlet to DC for use by module 200 and/or charging the battery. Another example of an adapter may be an adapter used with wheel chair batteries or other carts. In other exemplary embodiments, case 402 of mobility cart 400 may include a built-in power source configured to allow a portable infusion pump module that is docked in the case to directly plug-in to the power source through a power input terminal incorporated into the infusion pump module.

In exemplary embodiments, handle 408 of mobility cart 400 can also be provided with one or more clips 434 for affixing an outlet tube 436 from the oxygen concentration module or the infusion pump module. For example, clip 434 can be used to retain an oxygen delivery tube that allows delivery of oxygen to the patient for inhalation or a fluid delivery tube that is in communication with a conventional catheter assembly to provide fluid communication to an infusion site. Handle 408 may also be configured with various fasteners to connect to and support and carry objects as desired. For example, handle 408 can include a clamp for supporting an infusion bag that includes an infusion liquid such as physiological liquid, a drug suspended in liquid, or blood plasma to be administered to the patient through the infusion pump module.

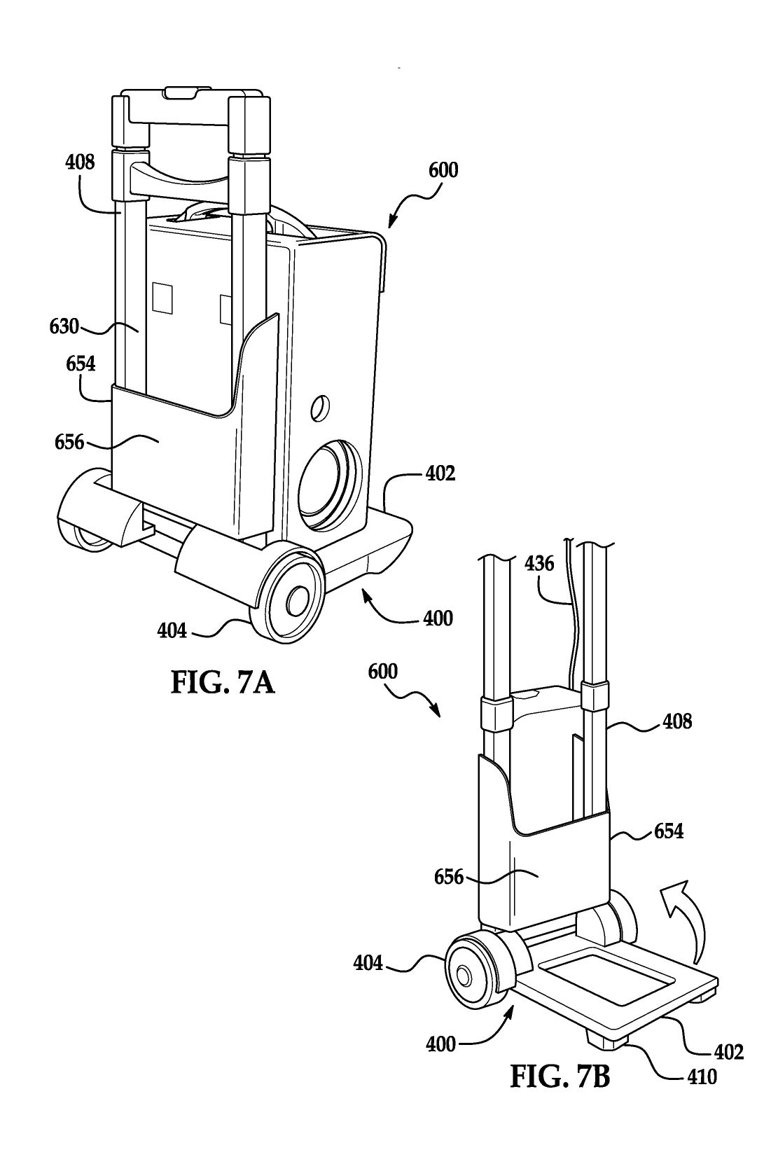

In exemplary embodiments, the mobility cart 400 and/or the carrying case 100 can be configured such that the carrying case can be removably attached to the mobility cart. For example, as depicted in the alternative exemplary embodiment illustrated in FIGS. 7a and 7b, a carrying case 600 for an oxygen concentration module for which mobility cart 400 is configured to operatively retain and support includes an attachment strap 654 on a rear side 630. Attachment strap 654 is configured to be received over handle 408 to allow carrying case 600 to be removably retained by mobility cart 400. In the exemplary embodiment depicted in FIGS. 7a and 7b, attachment strap 654 can be made from the same material as carrying case 600 (for example, a leather, canvas, netting, elastic, trilaminate, or nylon material), and can further include a midsection 656 made from a suitably flexible material such as an elastic that allows the attachment strap to be tightly secured to handle 408. Flexible midsection 656 can thereby also allow carrying case 600 to be spun around handle 408 such that the carrying case can also be retained by the handle on the opposing side of mobility cart, as depicted in FIG. 7b. As with the edges of external construction of the carrying case, attachment strap 656 can be hemmed or edge seamed to the carrying case by a simple stitch pattern to prevent unraveling. In other alternative exemplary embodiments, the mobility cart and the carrying case can be configured with any suitable combination of fastener members (for example, a belt buckle and holes or like fastening device) straps, holders, band, hooks and/or the like that allow for the carrying case to be removably secured to the mobility cart.

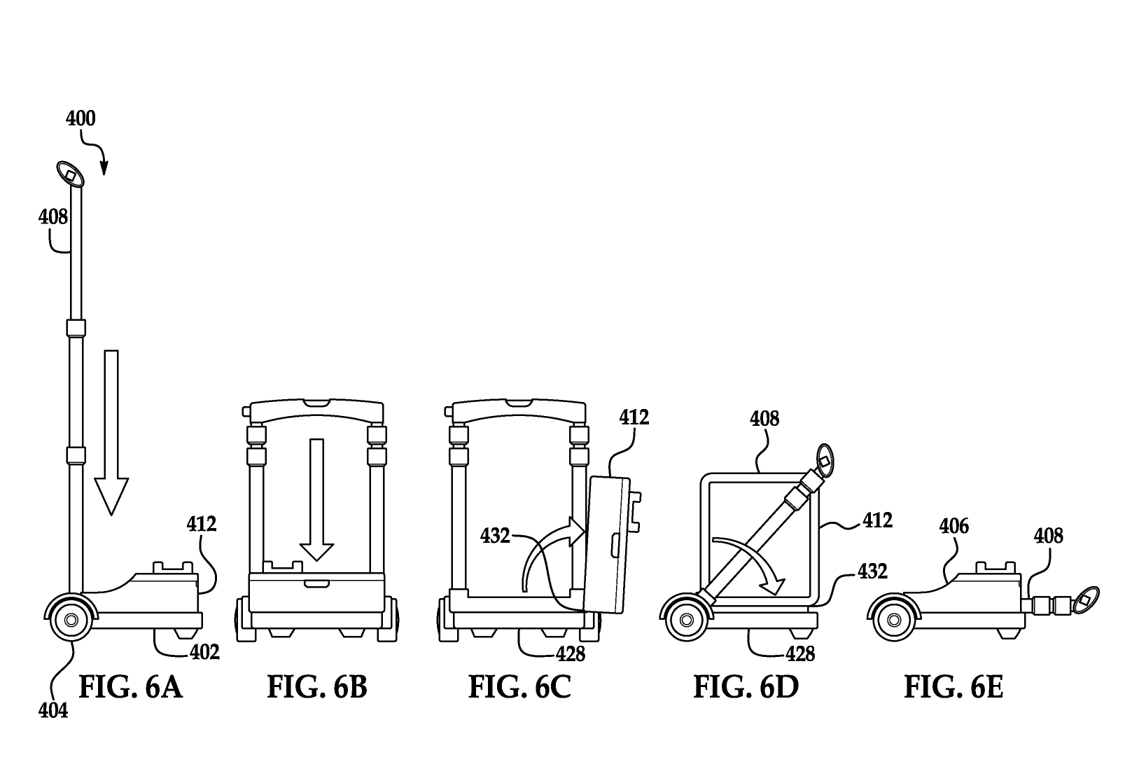

Mobility cart 400 is also adaptable to be folded down into a more compact cart that can be more easily transported when the cart is not being used to retain carrying case 100. The manner in which mobility cart 400 can be folded is illustrated in FIGS. 6a-6e, with arrows indicating the forces that are applied to perform the conversion. To fold mobility cart 400, handle 408 is first moved from a fully extended position, depicted in FIG. 6a, to a fully retracted position, depicted in FIG. 6b. Then, as shown in FIG. 6c, body portion 412 of case 402 is rotated about an edge of base platform 428 to expose base platform 428. To allow for body portion 412 to rotate in this fashion, the body portion is pivotally coupled to the edge of base platform 428 by a second hinge 432. In exemplary embodiments, second hinge 432 can comprise any suitable type of hinged joint structure that can provide for rotational motion such as, for example, a pivot joint, stiffened, flexible wire, or a swivel joint.

With body portion 412 now rotated to the side of base platform 428, handle 408 can be folded downward as shown in FIG. 6d. To fold downward in this manner, handle 408 can be configured to pivot about the longitudinal axis of rolling elements 404. Base platform 428 is formed with horizontally extending channels to receive and retain the two telescoping rails of handle portion 408 therein. After handle 408 is received in base platform 428, the handle can be locked in place by a fastening mechanism incorporated in the base platform (for example, spring pins), and body portion 412 can be rotated back to its original position above the base platform, as shown in FIG. 6e. At this point, mobility cart 400 has been folded into a more compact and portable form that can be more easily handled and stored in a small area such as, for example, underneath an airplane seat. Because handle 408 then extends outward from base platform 428, the handle can be lifted and used by a person to easily carry mobility cart 400 by rolling case 402 over the ground using wheels 404.

As discussed above, mobility cart 400 is configured to receive and securely retain a portable infusion pump module 500 in second inner compartment 420. Of course, as discussed above, the present exemplary embodiment is non-limiting, and it should be appreciated that mobility cart 400 and case 402 can be configured in various different shapes and sizes to accommodate various different types and designs of portable infusion pump modules. For better appreciation of the features provided by mobility cart 400 of the present exemplary embodiment, the operation and the components of portable infusion pump module 500 will now be described. Infusion pump module 500 comprises a housing 510 for retaining therewithin a controllable pumping apparatus, an electronic control means for controlling the operation of the controllable pumping apparatus, and a power supply unit. In the top wall of housing 510, two recesses are provided for receiving two tube connectors and constituting the aforementioned fluid inlet and fluid outlet, respectively. An inlet tube (not shown) establishes communication through the fluid inlet between infusion pump module 500 and an infusion bag, which may constitute an infusion bag including an infusion liquid simply constituting physiological liquid or additionally or alternatively a drug suspended in any appropriate liquid, or alternatively blood plasma. Infusion pump module 500 is connected to an outlet tube 518 through the fluid outlet. Outlet tube 518 can communicates with a conventional catheter assembly to provide fluid communication to an infusion site.

The controllable pumping apparatus retained within housing 510 has an inlet connected to the fluid inlet and an outlet connected to the fluid outlet for allowing transfer of fluid from said fluid inlet to said fluid outlet when the apparatus is operating. The controllable pumping apparatus can comprise, for example, a compact, piston-type pump actuator. The electronic control means can be configured to provide a number of different preset pumping programs for allowing infusion pump module 500 to be controlled in alternative infusion pumping operations. The power supply unit, which can comprise, for example, an internal rechargeable battery pack or cell, supplies power to the controllable pumping apparatus and to the electronic control means. At the one sidewall of housing 510, a power input terminal is provided for allowing the portable infusion pump module 500 to be connected to an electronic charger for supplying electric power to the power supply unit. The terminal may alternatively or additionally serve as input/output terminals for establishing communication between module 500 and an external apparatus or equipment such as an external data logging apparatus or surveillance apparatus or further alternatively for communicating with an external processing unit such as a personal computer or data logging apparatus.

A display is provided on the front of housing 510 for displaying digits representing the time lapsed or the time remaining for infusion operation expressed in minutes and hours, respectively, or seconds and minutes, respectively, or alternatively for displaying digits representing the supply of infusion liquid as expressed in volume per time unit (for example, milliliters per hour). The display can further include a display area for informing the patient and/or a person operating infusion pump module 500 or nursing the patient regarding the operational mode of the module, such as standby or running information (for example, information regarding whatever information is also presented on the display, such as the time remaining for infusion operation, the total time of the infusion operation, the presence of air in the infusion pump circuitry, any occurrence of a pressure fault or failure, an indication of a low battery, or any other relevant information to be presented to the patient or operator). Module 500 can also include a keyboard for allowing the patient/operator to direct the module to perform a specific operation or to program the module by shifting between specific program sequences.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiments disclosed as the best mode contemplated for carrying out this invention, but that the invention will include all embodiments falling within the scope of the appended claims.

What is claimed is:

1. An apparatus for operatively carrying and providing ready access to the operation of a portable oxygen concentration module, the apparatus comprising:
a carrying case having a hollow body portion defining a first inner chamber therein, a lower end configured to stabilize the carrying case in an upright position when the carrying case is rested on a generally planar surface, and an upper end defining a primary opening to the first inner chamber, the primary opening being sized and configured to permit the oxygen concentration module to be deposited into the first inner chamber therethrough, the first inner chamber being sized and configured to receive and operatively retain the oxygen concentration module therein;
a plurality of intake vents integrated within the hollow body portion, the intake vents being positioned to align with inlet vents of the oxygen concentration module when the oxygen concentration module is received within the first inner chamber to permit ambient air to be drawn into the oxygen concentration module from a surrounding atmosphere;
a plurality of exhaust vents integrated within the hollow body portion, the exhaust vents being positioned to align with outlet vents of the oxygen concentration module when the oxygen concentration module is received within the first inner chamber to permit exhaust gas to be vented from the oxygen concentration module to the surrounding atmosphere; and
a first aperture integrated within the carrying case, the first aperture being positioned to align with an outlet port of the oxygen concentration module when the oxygen concentration module is received within the first inner chamber to allow attachment of an oxygen delivery tube to the outlet port of the oxygen concentration module.

2. The apparatus of claim 1, further comprising a second aperture integrated within the carrying case, the second aperture being positioned to align with a power adapter input terminal of the oxygen concentration module when the oxygen concentration module is received within the first inner chamber to allow an external power adapter to be connected to the power adapter input terminal of the oxygen concentration module.

3. The apparatus of claim 1, further comprising a front flap portion having a first end and a second end, the first end of the front flap portion being connected to a rear side of the carrying case adjacent to the upper end, the front flap portion being configured to fold over the upper end of the carrying case, the second end of the front flap portion including a first fastener member configured to latch in releasable engagement with a second fastener member attached to a front side of the carrying case to close the primary opening when the front flap portion folded over the upper end of the carrying case and securely retain the oxygen concentration module within the first inner chamber when received therewithin.

4. The apparatus of claim 3, wherein the first aperture is integrated within the front flap portion.

5. The apparatus of claim 4, wherein the first aperture laterally extends across the upper end of the carrying case when the front flap portion folded over the upper end of the carrying case.

6. The apparatus of claim 3, wherein the hollow body portion and the front flap comprise leather, canvas, netting, elastic, nylon, trilaminate, or combinations thereof.

7. The apparatus of claim 1, wherein a plurality of elastic polymer feet project from the lower end of the carrying case.

8. The apparatus of claim 1, wherein the hollow body portion includes an interior wall lined with a sound-damping foam material.

9. The apparatus of claim 1, further comprising a widened strap having a first end and a second end, the first end being removably secured to a first side of the carrying case, the second end being removably secured to a second side of the carrying case, the widened strap being configured to overlie shoulders of a human body to enable the carrying case to be transported in loose movable relation to the human body.

10. The apparatus of claim 2, further comprising a side retaining strap projecting from a first side of the carrying case and a side pocket module, the side retaining strap being configured receive and removably retain the side pocket module therewithin, the side pocket module being sized and configured to retain the external power adapter therein, the side pocket module including a third aperture and a fourth aperture, the third aperture being positioned to align with the second aperture of the carrying case to permit a first power cable to extend from within the side pocket module to an interior the carrying case when the side pocket module is retained by the first restraining strap, the fourth aperture being configured to permit a power cord to extend therethrough to an exterior of the carrying case.

11. The apparatus of claim 3, wherein the first fastener member of the second end of the front flap portion is configured to latch in releasable engagement with the second fastener member attached to the front side of the carrying case proximate to the upper end of the carrying case, and further comprising a front retaining strap projecting from the front side of the carrying case and a front pocket module, the front retaining strap being configured receive and removably retain the front pocket module therewithin, the front pocket module being sized and configured to retain a battery pack for powering the oxygen concentration module therein.

12. A modular cart system for operatively transporting a carrying case for a portable oxygen concentration module and a portable infusion pump module, the modular cart system comprising:
a base platform horizontally extending from a first end to a second end;
a handle portion attached to the first end of the base platform, the handle portion having a pair of telescoping rails extending vertically upward to a crossbar portion, the telescoping rails being configured to extend to and releasably lock in an upper extended position, the telescoping rails being configured to retract to and releasably lock in a lower retracted position;
one or more rolling elements attached to the first end of the base platform, the one or more rolling elements being configured to operate in conjunction with the base platform stabilize the carrying case in an upright position when the carrying case is rested on a generally planar surface, the one or more rolling elements being configured to facilitate rolling movement of the modular cart system over a ground surface upon tilting of the base platform and the handle portion to a movable position and application of lateral force to the handle portion; and
a case operatively supported by the base platform and having a generally rectangular cross-section, the case having an upper panel, the upper panel having a substantially arcuate support portion adjacent to the telescoping rails of the handle portion, the support portion being sized and configured to receive the carrying case for the oxygen concentration module and to operate in conjunction with the telescoping rails to retain the carrying case, the case providing a first inner compartment sized and configured to receive and operatively retain the infusion pump module therein.

13. The modular cart system of claim 12, wherein the case is removably attached to the base platform such that the case can be completely detached from the base platform and transported separately.

14. The modular cart system of claim 12, wherein the modular cart system is configured to be collapsed such that the one or more rolling elements facilitate rolling movement of the modular cart system over the ground surface upon lifting of the base platform and the handle portion to a movable position and application of lateral force to the handle portion.

15. The modular cart system of claim 14, wherein a first side of a lower panel of the case is rotatively coupled by a first hinge to a first side of the base platform such that the case is rotatable about the first side of the base platform to a first position and a second position, the lower panel of the case extending longitudinally across the base platform in releasable engagement with the base platform when the case is disposed in the first position, the lower panel of the case extending vertically upward transversely to the base platform when the case is disposed in the second position, wherein the handle portion is rotatively coupled by a second hinge to the first end of the base platform such that the handle portion is rotatable about the first side of the base platform to a third position and a fourth position when the when the case is disposed in the second position, the telescoping rails extending vertically upward transversely to the base platform when the handle portion is disposed in the third position, the telescoping rails extending longitudinally across the base platform when the handle portion is disposed in the fourth position, wherein the base platform is configured to receive and operatively retain the telescoping rails when the handle portion is disposed in the fourth position, and wherein the case is rotatable from the second position to the first position when the handle portion is disposed in the fourth position to extend longitudinally the handle portion and across the base platform in releasable engagement with the base platform such that the one or more rolling elements facilitate rolling movement of the modular cart system over the ground surface upon lifting of the base platform and the handle portion to a movable position and application of lateral force to the handle portion.

16. The modular cart system of claim 12, wherein the upper panel of the case includes a removable lid that provides an opening to the first inner compartment when removed from the case, the primary opening being sized and configured to permit the infusion pump module to be deposited into the first inner compartment therethrough.

17. The modular cart system of claim 12, wherein the case provides a second inner compartment that is configured to receive and operatively retain a battery pack for the infusion pump module, a power adapter for the infusion pump module, a travel first aid kit, a fluid delivery tube and catheter assembly, a fluid infusion bag, medical diagnostic equipment, a prescription medication container, a beverage container, or combinations thereof.

18. The modular cart system of claim 12, further comprising a power adapter integrated within the case, the power adapter being configured to supply power from a power source to the oxygen concentration module, the infusion pump module, or both.

19. The modular cart system of claim 12, wherein the crossbar of the handle portion includes a clip configured to retain an oxygen delivery tube, a fluid delivery tube, or both.

20. The modular cart system of claim 12, wherein the carrying case for the oxygen concentration module comprises:
a hollow body portion defining a first inner chamber therein;
a lower end configured to stabilize the carrying case in an upright position when the carrying case is rested on a generally planar surface;
an upper end defining a primary opening to the first inner chamber, the primary opening being sized and configured to permit the oxygen concentration module to be deposited into the first inner chamber therethrough, the first inner chamber being sized and configured to receive and operatively retain the oxygen concentration module therein;
a plurality of intake vents integrated within the hollow body portion, the intake vents being positioned to align with inlet vents of the oxygen concentration module when the oxygen concentration module is received within the first inner chamber to permit ambient air to be drawn into the oxygen concentration module from a surrounding atmosphere;
a plurality of exhaust vents integrated within the hollow body portion, the exhaust vents being positioned to align with outlet vents of the oxygen concentration module when the oxygen concentration module is received within the first inner chamber to permit exhaust gas to be vented from the oxygen concentration module to the surrounding atmosphere; and
a first aperture integrated within the carrying case, the first aperture being positioned to align with an outlet port of the oxygen concentration module when the oxygen concentration module is received within the first inner chamber to allow attachment of an oxygen delivery tube to the outlet port of the oxygen concentration module.
